(19) United States
(12) Patent Application Publication
(10) Pub. No.: US 2012/0234144 A1
(43) Pub. Date: Sep. 20, 2012

(54) METHODS FOR SHEET REGISTRATION AND SHEARING

(76) Inventors: Craig C. Tormoen, Poynette, WI (US); Darrin P. Wastlick, Lone Rock, WI (US)

(21) Appl. No.: 13/423,995

(22) Filed: Mar. 19, 2012

Related U.S. Application Data
(60) Provisional application No. 61/453,736, filed on Mar. 17, 2011.

(51) Int. Cl. B21D 43/00; B26D 7/01; B23D 79/00

(52) U.S. Cl. 83/36; 414/816; 83/13

(57) ABSTRACT

Methods of registering and shearing a sheet including grasping the sheet using a manipulator of an industrial robot and locating two adjacent edges of the sheet.

### CROSS-REFERENCE TO RELATED APPLICATION

This application claims the benefit of U.S. Provisional Patent Application No. 61/453,736 filed Mar. 17, 2011, the disclosure of which is hereby incorporated by reference in its entirety.

### STATEMENT REGARDING FEDERALLY SPONSORED RESEARCH OR DEVELOPMENT

Not applicable.

### FIELD OF THE INVENTION

The present invention relates to methods for shearing sheets of material, and more particularly to methods for registering and squaring sheet metal.

### BACKGROUND OF THE INVENTION

Metal stock flattened by rolling processes is sometimes cut into sheets before conducting subsequent manufacturing processes, such as bending and drawing. However, such sheets initially have irregular edges (i.e., jagged edges that are not necessarily perpendicular to one another) due to the rolling processes or subsequent coarse cutting processes. For this reason, edges of sheet metal are often “squared” (i.e., sheared to make perpendicular; the sheet metal is not necessarily cut to a square shape) before subsequent manufacturing processes.

Sheet metal is typically squared using mechanically driven shears that cut along a straight line. Such a cutting process is relatively fast; for example, some shears are capable of cutting an edge in less than a second. However, the time required for an operator to register a sheet (i.e., to reposition the sheet so that features are appropriately positioned relative to the shears) is relatively long due to the amount of care that must be exercised to accurately move the sheet. In some cases, more than ten minutes are needed for an operator to register a sheet.

Considering the amount of time needed for an operator to register a sheet, it would be desirable to have an improved method for shearing sheets and an improved method for registering sheets during such a process.

### SUMMARY OF THE INVENTION

In one aspect, the present invention provides a method of registering a sheet. The method includes the steps of grasping the sheet using a manipulator of an industrial robot and locating a first edge of the sheet by: a) pivoting said sheet about a first pivot axis until said first edge is substantially aligned parallel with a first line; and b) pivoting said sheet about a second pivot axis until a point of said first edge coincides with said first line. The method further includes locating a second edge of said sheet adjacent to said first edge by translating said sheet using said manipulator.

In another aspect, the present invention provides a method of shearing a sheet. The method comprises the steps of grasping the sheet using a manipulator of an industrial robot and establishing a three-point datum for the sheet by a) moving the sheet toward a first location until a first point of a first edge of the sheet coincides with the first location, and the first point is established as a first datum point of the three-point datum; b) pivoting the sheet about the first datum point until a second point of the first edge coincides with a second location, and the second point is established as a second datum point of the three-point datum; and c) moving the sheet toward a third location until a first point of a second edge of the sheet coincides with the third location, and the first point of the second edge is established as a third datum point of the three-point datum. The method further comprises the steps of releasing the sheet from the manipulator and moving the manipulator to a reference point and a reference orientation while the sheet is released. The method further comprises the steps of grasping the sheet using the manipulator and moving the sheet toward shears until one edge of the sheet is located at a shearing position. The one edge is sheared using the shears.

The foregoing and advantages of the invention will appear from the following description. In the description, reference is made to the accompanying drawings which form a part hereof, and in which there is shown by way of illustration preferred embodiments of the invention. Such embodiments do not necessarily represent the full scope of the invention, however, and reference is made therefore to the claims herein for interpreting the scope of the invention.

### BRIEF DESCRIPTION OF THE DRAWINGS

The invention will hereafter be described with reference to the accompanying drawings, wherein like reference numerals denote like elements, and:

FIG. 1 is a flowchart for a method of sheet registration according to the present invention;

FIG. 2 is a side view of an industrial robot configured to perform the method shown in FIG. 1;

FIG. 3 is a side view of the industrial robot placing a sheet on a work surface according to the method of FIG. 1;

FIG. 4 is a top view of the industrial robot pivoting the sheet about an initial pivot axis according to the method of FIG. 1;

FIG. 5 is a top view of the industrial robot translating the sheet towards first and second sensors according to the method of FIG. 1;

FIG. 6 is a top view of a first edge of the sheet triggering a first sensor according to the method of FIG. 1;

FIG. 7 is a top view of the industrial robot pivoting the sheet about a first datum point according to the method of FIG. 1;

FIG. 8 is a top view of the first edge of the sheet triggering a second sensor according to the method of FIG. 1;

FIG. 9 is a top view of the industrial robot translating the sheet toward a third sensor according to the method of FIG. 1; and

FIG. 10 is a top view of a second edge of the sheet triggering the third sensor according to the method of FIG. 1.

### DETAILED DESCRIPTION OF THE PREFERRED EMBODIMENT

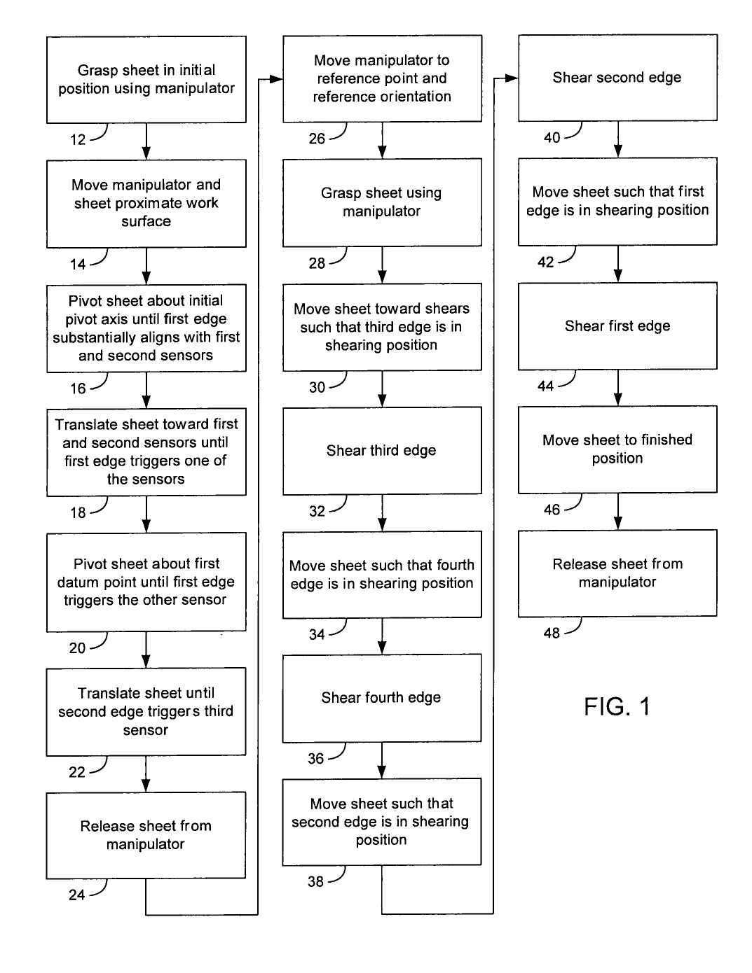

The method of squaring a sheet shown in FIG. 1 is preferably used in connection with sheet metal. However, sheets of other types of materials may also be used, such as composite materials and the like. In any case, a sheet 60 is first grasped at an initial position (e.g., the top of a stack of sheets) by a manipulator 62 of an industrial robot 63 at step 12. The manipulator 62 may grasp the sheet 60 via suction or a vacuum, although other well-known methods for grasping a sheet 60 using a robotic manipulator may alternatively be used. Regardless of the manner in which the sheet 60 is grasped, the industrial robot 63 provides the manipulator 62 with six degrees of freedom. Such industrial robots include those manufactured by ABB, Zurich, Switzerland, and include a controller (not shown) capable of being programmed with the initial nominal dimensions and manufacturing tolerances (i.e., initial straightness and perpendicularity of the edges) of the sheet 60. This aspect of the invention is described in further detail below.

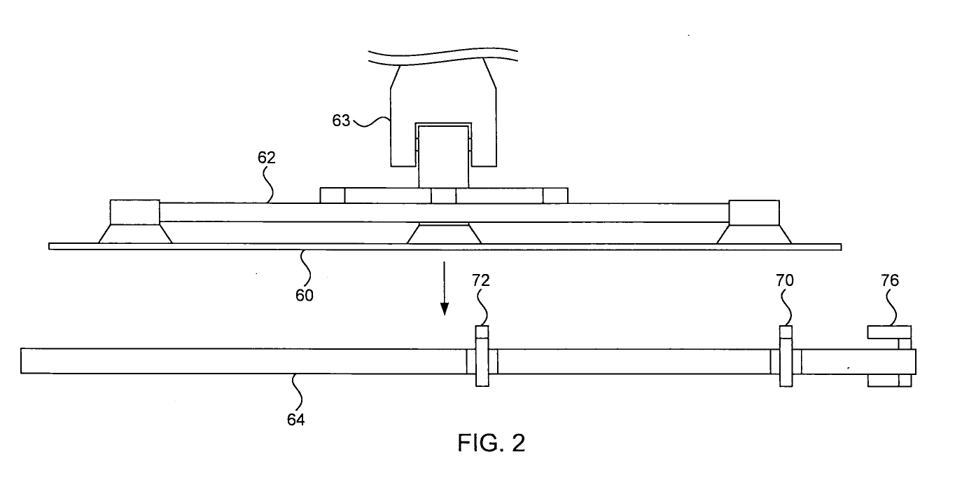

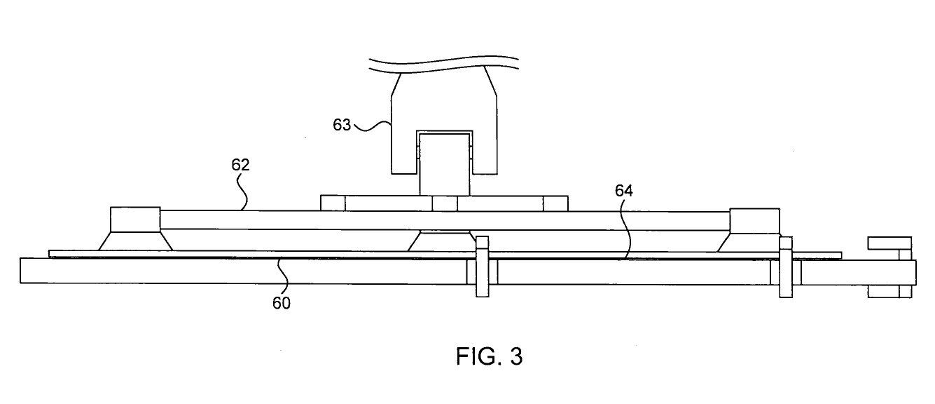

The manipulator 62 and the sheet 60 next move to a position proximate a work surface 64 at step 14 (see also FIGS. 2 and 3) The lower surface of the sheet 60 preferably contacts the work surface 64, although the sheet 60 may alternatively be located slightly there above. Hereafter, the manipulator 62 moves in a sequence that registers the sheet 60 relative to the work surface 64, or stated another way, establishes a datum for the sheet 60. In particular, the manipulator 62 registers the sheet 60 by locating two adjacent edges of the sheet 60.

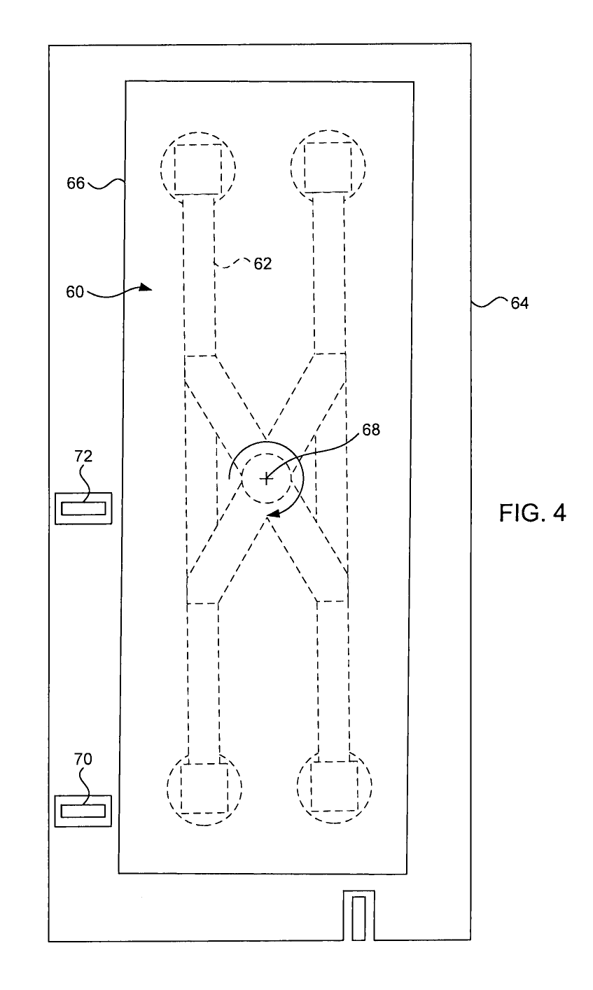

To locate a first edge 66 of the sheet 60, the manipulator 62 first pivots the sheet 60 about an initial pivot axis 68 (e.g., an axis extending perpendicularly to the work surface 64 and through the center of the manipulator 62) to substantially align the first edge 66 parallel to a line extending through a first sensor 70 and a second sensor 72 at step 16 (see also FIG. 4). The first sensor 70 and the second sensor 70 may be any of various well-known types, such as infrared proximity sensors, capacitive proximity sensors, inductive proximity sensors, electromagnetic proximity sensors, machine vision devices, or any other type that is triggered when a point on an edge of the sheet 60 coincides therewith.

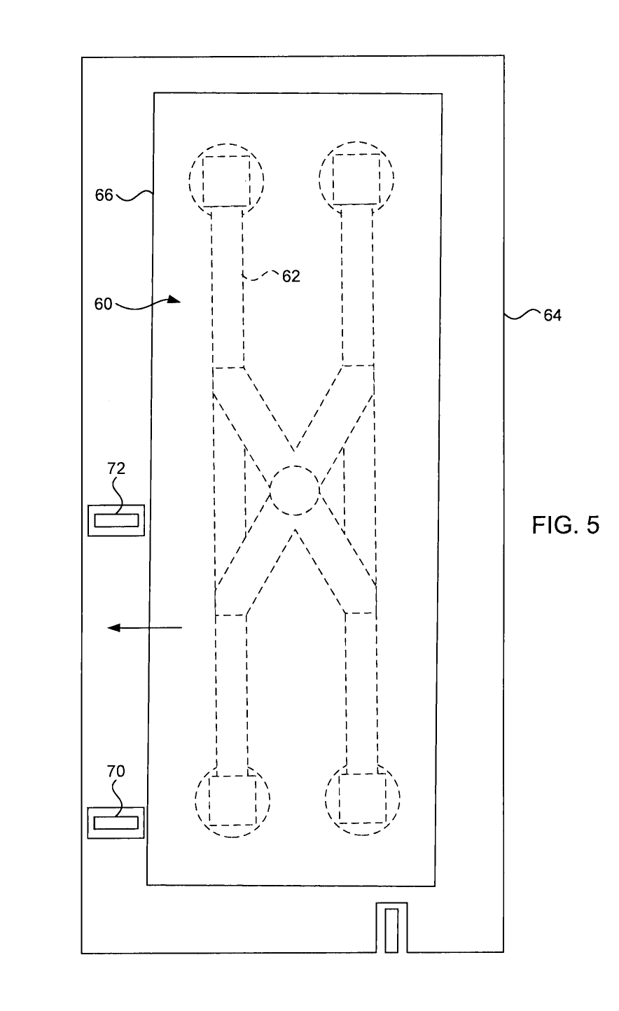

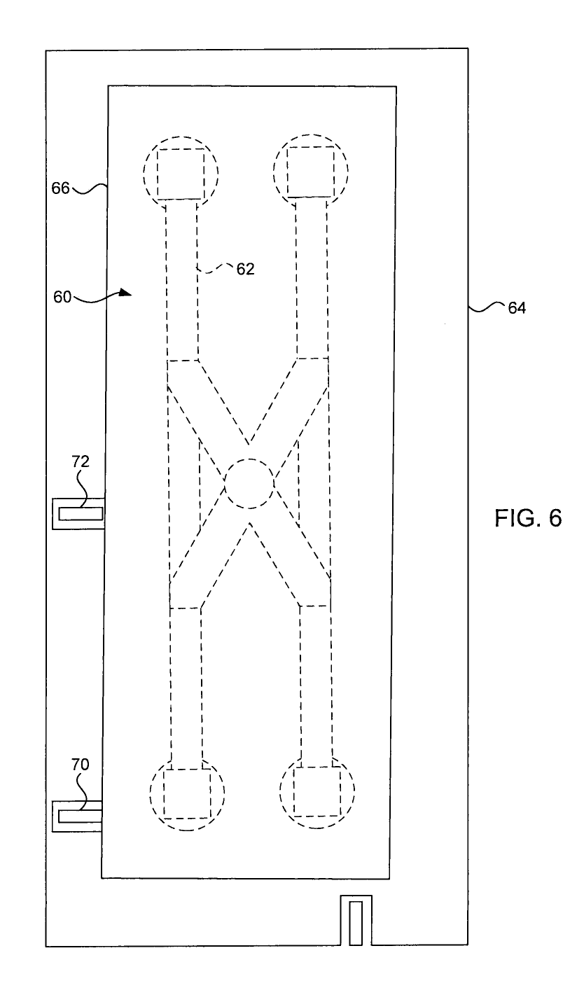

The manipulator 62 then translates the sheet 60 toward the sensors 70, 72 until a point on the first edge 66 of the sheet 60 triggers one of the sensors 70, 72 at step 18 (see also FIGS. 5 and 6). This point on the first edge 66 is established as a first datum point.

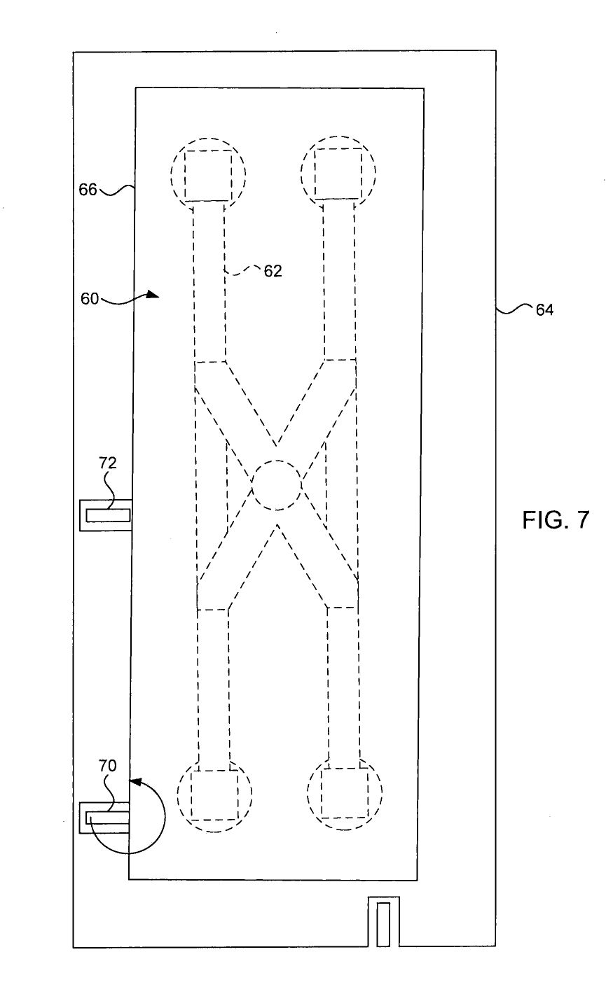

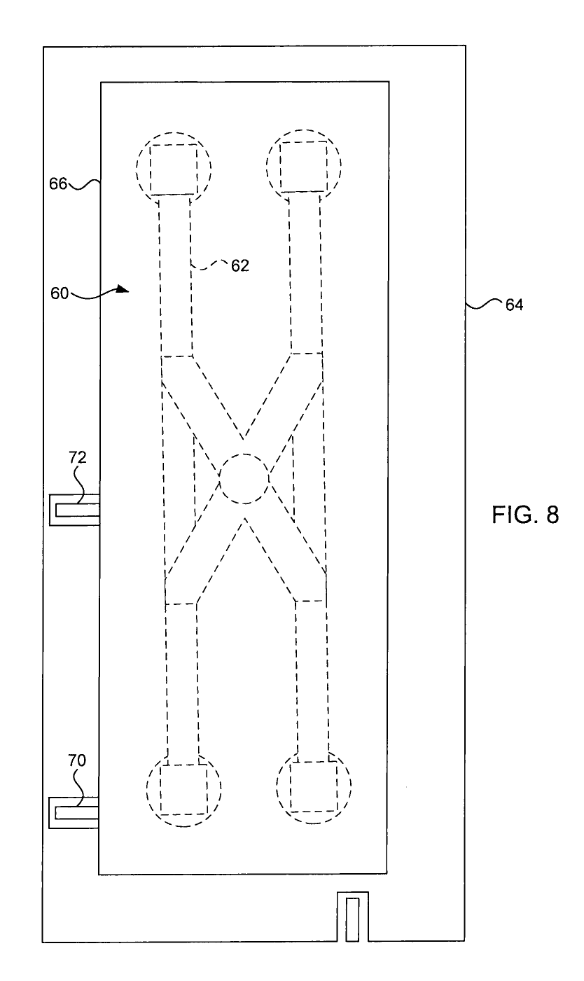

Next, the manipulator 62 pivots the sheet 60 about the first datum point (a virtual pivot point extending through, e.g., the first sensor 70) at step 20 (see also FIG. 7). The manipulator 62 continues pivoting the sheet 60 about the first datum point until the first edge 66 triggers the other of the sensors 70, 72 (see also FIG. 8). The point on the first edge 66 that triggers this sensor 70, 72 is established as a second datum point. Furthermore, this motion locates the first edge 66 of the sheet 60 and establishes a datum line extending through the first and second datum points that intersects both the first sensor 70 and the second sensor 72.

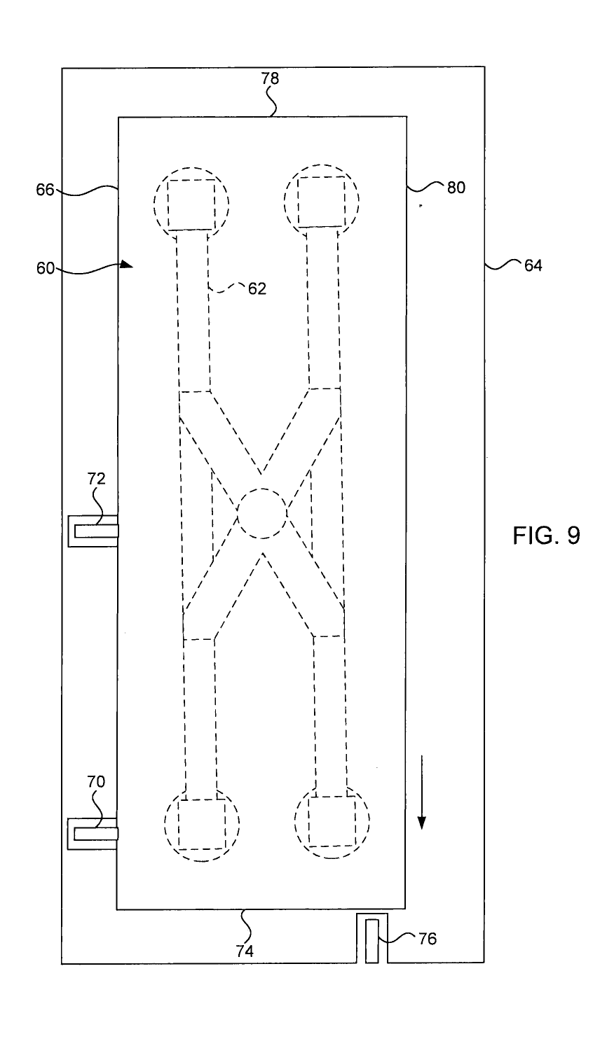

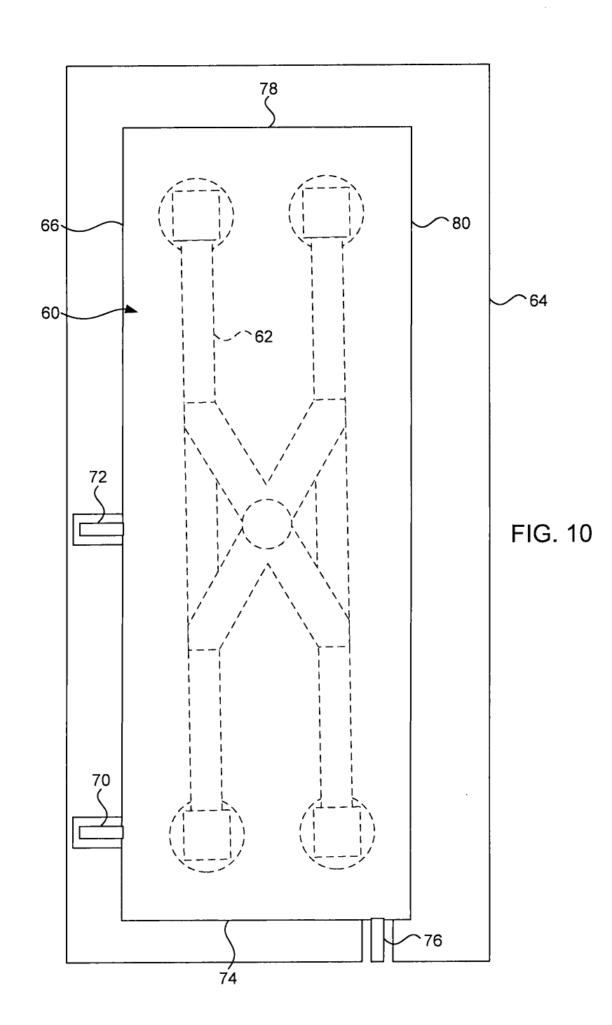

To locate an adjacent second edge 74 of the sheet 60, the manipulator then translates the sheet 60 along the datum line at step 22 (see also FIG. 9). The manipulator 62 continues translating the sheet 60 until the second edge 74 triggers a third sensor 76 (see also FIG. 10). The third sensor 76 may be any of the well-known types described above or any other type that is triggered when a point on the second edge 74 coincides therewith. In any case, this motion locates the second edge 74 along an axis extending through the third sensor 76 (or only a portion of the second edge 74 is positioned along the axis, depending on the straightness of the second edge 74 and its perpendicularity to the first edge 66). Stated another way, the point on the second edge 74 is established as a third datum point.

After locating two adjacent edges of the sheet 60 as described above, the manipulator 62 moves the sheet 60 in a sequence that permits shears (not shown) to square the sheet 60. To this end, the manipulator 62 first releases the sheet 60 at step 24 and then the manipulator 62 is repositioned relative to a reference point and a reference orientation (e.g., a known distance from the datum line and the third datum point) above the sheet 60 at step 26. The manipulator 62 then moves toward and grasps the sheet 60 at step 28.

The manipulator 62 translates the sheet 60 toward the shears such that a third edge 78 of the sheet 60 enters a shearing position (i.e., a position in which the third edge 78 is located between the pair of shears) at step 30. The distance the manipulator 62 translates such that the third edge 78 enters the shearing position is based on the initial nominal dimensions and manufacturing tolerances of the sheet 60. Regardless of the specific distance the manipulator 62 translates, the shears engage and thereby shear the third edge 78 at step 32.

The manipulator 62 then rotates the sheet 60 by 90 degrees and translates the sheet 60 such that a fourth edge 80 of the sheet 60 enters the shearing position at step 34. Again, the distance the manipulator 62 translates such that the fourth edge 80 enters the shearing position is based on the initial nominal dimensions and manufacturing tolerances of the sheet 60. The shears engage and thereby shear the fourth edge 80 at step 36.

Next, the manipulator 62 rotates the sheet 60 by an additional 90 degrees and translates the sheet 60 such that the second edge 74 enters the shearing position at step 38. Once again, the distance the manipulator 62 translates such that the second edge 74 enters the shearing position is based on the initial nominal dimensions and manufacturing tolerances of the sheet 60. The shears engage and thereby shear the second edge 74 at step 40.

The manipulator 62 then rotates the sheet 60 by yet another 90 degrees and translates the sheet 60 such that the first edge 66 enters the shearing position at step 42. Once again, the distance the manipulator 62 translates such that the first edge 66 enters the shearing position is based on the initial nominal dimensions and manufacturing tolerances of the sheet 60. The shears engage and thereby shear the first edge 66 at step 44, thereby providing a squared sheet 60.

Finally, the manipulator 62 moves the sheet 60 to a finished position (e.g., a stack of squared sheets) at step 46 and releases the sheet 60 at step 48.

The methods described above may be modified in various manners. For example, the order in which the edges of the sheet 60 are sheared could be changed. As another example, the sheet 60 may be pivoted about the initial pivot axis 68 instead of translated to trigger the first sensor 70. As yet another example, additional datum points on the sheet 60 could be established or additional edges could be located to ensure the sheet 60 is within manufacturing tolerances. Furthermore, instead of or in addition to shearing the edges of the sheet 60, other portions of the sheet 60 could be sheared to change the nominal shape of the sheet. For example, the corners of the sheet 60 could be cut to form a chamfered corner or the sheet 60 could be cut to a different shape, such as a triangle or the like.

As yet another alternative, the methods described above could be modified so that the first edge 66 is not sheared in some situations. These situations include those in which the sheet 60 was initially cut along the first edge 66 from a larger piece of stock using shears.

From the above description, it should be apparent that the present invention provides improved methods for registering and squaring sheets. In particular, these methods are significantly faster than previous methods due to the speed and accuracy with which the industrial robot moves and registers sheets.

While there has been shown and described what is at present considered the preferred embodiment of the invention, it will be obvious to those skilled in the art that various changes and modifications can be made therein without departing from the scope of the invention defined by the appended claims.

We claim:

1. A method of registering a sheet, comprising the steps of:
grasping said sheet using a manipulator of an industrial robot;
locating a first edge of said sheet by:
a) pivoting said sheet, using said manipulator, about a first pivot axis until said first edge is substantially aligned parallel with a first line;
b) pivoting said sheet, using said manipulator, about a second pivot axis, said second pivot axis being offset from said first pivot axis, until a point of said first edge coincides with said first line; and
locating a second edge of said sheet adjacent to said first edge by translating said sheet using said manipulator.

2. The method of claim 1, wherein locating said first edge further includes, after pivoting said sheet about said first pivot axis, translating said sheet towards said first line until another point of said first edge coincides with said first line.

3. The method of claim 2, wherein said second pivot axis intersects said first line and said another point.

4. The method of claim 1, wherein the steps of pivoting said sheet about said first pivot axis, pivoting said sheet about said second pivot axis, and translating said sheet each include moving said sheet in a substantially horizontal plane.

5. A method of establishing a datum for a sheet by identifying at least three datum points on said sheet, comprising the steps of:
grasping said sheet using a manipulator of an industrial robot;
moving said sheet, using said manipulator, toward a first location until a first point of a first edge of said sheet coincides with said first location, said first point being a first datum point of said at least three datum points;
pivoting said sheet, using said manipulator, about said first datum point until a second point of said first edge coincides with a second location, said second point being a second datum point of said at least three datum points; and
moving said sheet, using said manipulator, toward a third location until a first point of a second edge of said sheet coincides with said third location, said first point of said second edge being a third datum point of said at least three datum points.

6. The method of claim 5, wherein said first edge is adjacent said second edge.

7. The method of claim 5, wherein moving said sheet toward said first location includes translating said sheet toward said first location.

8. The method of claim 5, wherein moving said sheet toward said third location includes translating said sheet toward said third location.

9. The method of claim 5, wherein moving said sheet toward said first location includes moving said sheet until a first sensor disposed at said first location indicates said first point on said first edge coincides with said first location.

10. The method of claim 9, wherein pivoting said sheet about said first datum point includes pivoting said sheet until a second sensor disposed at said second location indicates said second point coincides with said second location.

11. The method of claim 10, wherein moving said sheet toward said third location includes moving said sheet until a third sensor disposed at said third location indicates said first point on said second edge coincides with said third location.

12. The method of claim 5, wherein pivoting said sheet about said first datum point including pivoting said sheet about a virtual pivot point.

13. The method of claim 5, wherein the steps of moving said sheet toward said first location, pivoting said sheet about said first datum point, and moving said sheet toward said third location each include moving said sheet in a substantially horizontal plane.

14. A method of shearing a sheet, comprising the steps of:
grasping said sheet using a manipulator of an industrial robot;
establishing a three-point datum for said sheet by:
a) moving said sheet, using said manipulator, toward a first location until a first point of a first edge of said sheet coincides with said first location, said first point being a first datum point of said three-point datum;
b) pivoting said sheet, using said manipulator, about said first datum point until a second point of said first edge coincides with a second location, said second point being a second datum point of said three-point datum;
c) moving said sheet, using said manipulator, toward a third location until a first point of a second edge of said sheet coincides with said third location, said first point of said second edge being a third datum point of said three-point datum;
releasing said sheet from said manipulator;
moving said manipulator to a reference point and a reference orientation while said sheet is released;
grasping said sheet using said manipulator;
moving said sheet, using said manipulator, toward shears until one edge of said sheet is located at a shearing position; and
shearing said one edge using said shears.

15. The method of claim 14, wherein said one edge is a third edge of said sheet opposite said second edge and adjacent said first edge.

16. The method of claim 15, further comprising the steps of:
moving said sheet, using said manipulator, toward said shears until a fourth edge of said sheet is located at said shearing position;
shearing said fourth edge using said shears; and
wherein said fourth edge is opposite said first edge and adjacent said second edge.

17. The method of claim 16, further comprising the steps of:
moving said sheet, using said manipulator, toward said shears until said second edge is located at said shearing position; and
shearing said second edge using said shears.
